(19) United States
(12) Patent Application Publication
(10) Pub. No.: US 2003/0155438 A1
(43) Pub. Date: Aug. 21, 2003

(54) Fuel injection valve

(76) Inventors: Matthias Boee, Ludwigsburg (DE); Guenther Hohl, Stuttgart (DE); Norbert Keim, Loechgau (DE)

Correspondence Address: KENYON & KENYON, ONE BROADWAY, NEW YORK, NY, 10004, US

(21) Appl. No.: 10/168,163

(22) PCT Filed: Dec. 14, 2000
(86) PCT No.: PCT/DE00/04452

(30) Foreign Application Priority Data
Dec. 15, 1999 (DE) 199 60 341.3

(51) Int. Cl. F02M 59/00

(52) U.S. Cl. 239/533.2

(57) ABSTRACT

A fuel injector (1) for fuel injection systems of internal combustion engines is constructed of a solenoid (8), an armature (12) which is acted upon in a closing direction by a restoring spring (10), and a valve needle (3) which is frictionally engaged with the armature (12) to actuate a valve-closure member (4) which together with a valve-seat surface (6) forms a sealing seat. In or on the armature (12) at least a first fuel channel (37) is provided through which fuel flows, where the cross-section of the first fuel channel (37) is dependent on the axial position of the armature (12).

### BACKGROUND INFORMATION

The present invention relates to a fuel injector according to the preamble of the main claim.

An electromagnetically actuatable fuel injector is already known from German Patent Application 195 03 821 A1, in which an armature cooperates with an electrically excitable solenoid to cause the electromagnetic actuation, and the lift of the armature is transferred via a valve needle to a valve-closure member. The valve-closure member cooperates with a valve-seat surface to form a sealing seat.

A disadvantage of the fuel injector known from German Patent Application 195 03 821 A1 is in particular the relatively long closing times. Delays in closing the fuel injector are caused by the adhesive forces operating between the armature and the internal pole and by the non-instantaneous decay of the magnetic field when the exciting current is turned off. This results in improvable metering times and metered quantities for the fuel.

### ADVANTAGES OF THE INVENTION

The fuel injector according to the present invention having the characterizing features of the main claim has the advantage over the related art that when a fuel channel with position-dependent cross-section is incorporated into the armature, the fuel builds up dynamic pressure in the armature, which operates in the direction of closure during the closing movement and accelerates the release of the armature from the internal pole. During the opening movement the dynamic pressure is considerably less, since the position-dependent cross-section of the fuel channel is largely open. The opening time therefore remains largely unimpaired by the measure according to the present invention. The quicker release of the armature from the internal pole as the magnetic field decays results in shorter closing times for the fuel injector, and thus in shorter and more precise fuel metering times and quantities. The fact that the activation power of the solenoid does not need to be increased to achieve shorter closing times is also advantageous.

The measures listed in the subclaims make advantageous refinements of and improvements on the fuel injector described in the main claim possible.

A second fuel channel whose cross-section is independent of the position of the armature is provided advantageously in the armature. This channel takes over the supplying of the fuel when the fuel injector is in the open position.

Especially advantageous is the problem-free and economical production of an armature with appropriate bores and equalizing channels.

### DRAWING

One embodiment of the present invention is illustrated in simplified form in the drawing and explained in greater detail in the following description.

FIG. 1 shows an axial partial section through an embodiment of a fuel injector according to the present invention.

FIG. 2 shows an enlarged detail in area II of FIG. 1, depicting the fuel injector in its open state.

FIG. 3 shows an enlarged detail in area II of FIG. 1, depicting the fuel injector in its closed state.

### DETAILED DESCRIPTION OF THE EMBODIMENT

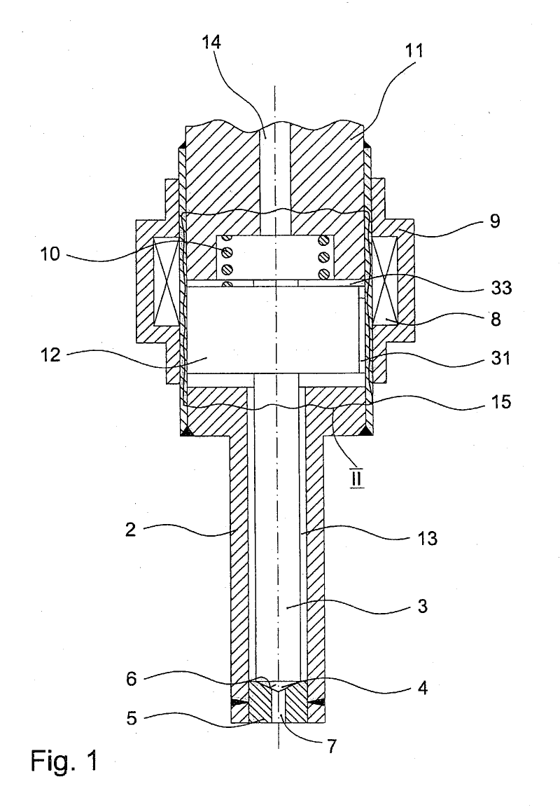

A fuel injector 1 depicted in FIG. 1 is used in particular for direct injection of fuel into the combustion chamber of an internal combustion engine having spark ignition and fuel mixture compression. Fuel injector 1 includes a solenoid 8 which is encapsulated in a coil housing 9, a tube-shaped internal pole 11 and a sleeve-shaped stationary pole 15 which is welded to a nozzle body 2. An armature 12, which is acted on by a restoring spring 10, contains at least one equalizing channel 31, through which the centrally supplied fuel is fed through a recess 13 in nozzle body 2 to the sealing seat. Armature 12 is mechanically linked to a valve needle 3, which is formed into a valve-closure member 4 in the injection direction. Valve-closure member 4 together with a valve-seat surface 6, which is formed on a valve-seat member 5, forms a sealing seat. This embodiment is an inward-opening fuel injector 1. At least one injection orifice 7 is formed in valve-seat member 5.

In the resting state of fuel injector 1, armature 12 is acted upon by restoring spring 10 against its direction of lift, so that valve-closure member 4 is held in sealing contact on valve-seat surface 6. When solenoid 8 is excited, it builds up a magnetic field which moves armature 12 in the direction of lift against the elastic force of restoring spring 10. Armature 12 also entrains valve needle 3 in the direction of lift. Valve-closure member 4, which is formed in a single piece with valve needle 3 in this embodiment, is lifted up from valve-seat surface 6, and fuel is conducted past the sealing seat into the at least one injection orifice 7.

When the coil current is turned off, armature 12 drops back from internal pole 11 due to the pressure of restoring spring 10, so that valve needle 3, which is mechanically linked to armature 12, moves against the direction of lift, valve-closure member 4 drops onto valve-seat surface 6, and fuel injector 1 is closed.

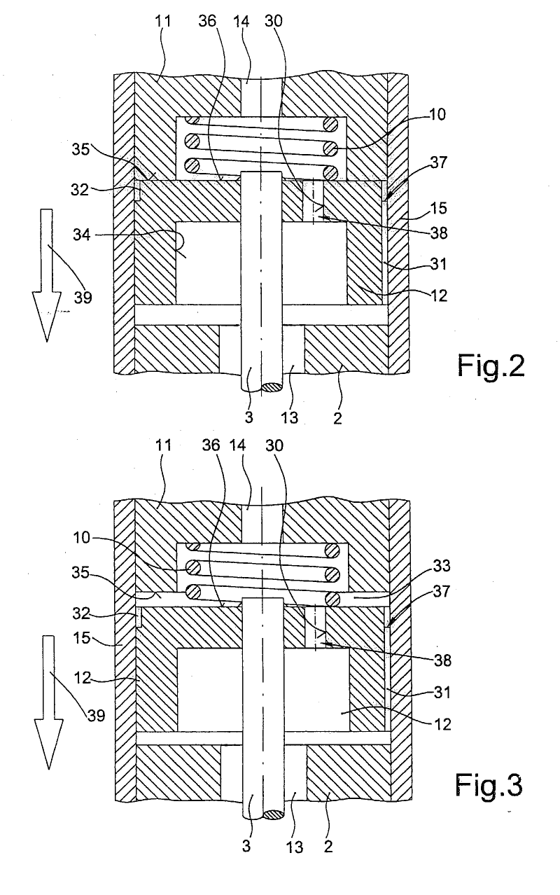

FIG. 2 shows a schematic axial sectional detail of area II in FIG. 1 of fuel injector 1 according to the present invention in its open state. The enlarged view shows only the components which are of major significance in reference to the present invention. The design of the other components may be identical to a known fuel injector. Elements which have already been described are given corresponding reference symbols in all figures, so that a repetition of the description is unnecessary.

In FIG. 2 armature 12 is in contact with internal pole 11 and fuel injector 1 is open. On internal pole 11 and/or armature 12 there is for example a thin wear-resistant chromium layer 35 which functions as a residual magnetic air gap. A working gap 33 between internal pole 11 and armature 12 and equalizing channels 31 which connect to it axially form a first fuel channel 37. In the open state of fuel injector 1 the fuel is prevented from flowing through working gap 33 and equalizing channels 31, since working gap 33 is closed. The fuel therefore flows exclusively through a bore 30 in armature 12, which forms a second fuel channel 38, into a central recess 34 of armature 12 and on through ring-shaped recess 13 formed around valve needle 3 in the direction of the sealing seat. Through appropriate dimensioning of bore 30, when fuel injector 1 is open, dynamic pressure develops upstream from armature 12, which operates in the direction of closure. This accelerates the release of armature 12 from internal pole 11 after the exciting current is turned off. Since armature stop face 36 is relatively large, a dynamic pressure of a few bars (a small percentage of the infeed pressure) is sufficient. Thus the maximum flow rate of fuel injector 1 remains nearly unchanged.

FIG. 3 shows an axial sectional detail of area II in FIG. 1 of fuel injector 1 according to the present invention in its closed state.

When the current which excites solenoid 8 is turned off, after sufficient decay of the magnetic field armature 12, which is acted on by restoring spring 10 and also by the dynamic pressure exerted by the fuel, drops back from internal pole 11 in the direction of closure. As soon as working gap 33 begins to open, fuel flows into an armature annulus 32 which is preferably milled into armature 12 to improve fuel distribution, and flows through equalizing channels 31 into recess 13.

In the closed state of fuel injector 1 and at the beginning of the opening operation, due to equalizing channels 31, no significant dynamic pressure is built up, or in any case a lower dynamic pressure than in the open state. When solenoid 8 is excited by an exciting current, armature 12 moves against the closing direction indicated by arrow 39 to internal pole 11. Valve-closure member 4 is lifted up from valve-seat surface 6 and the volumetric flow through fuel injector 1 begins. The fuel flows through bores 30 and equalizing channels 31. The opening operation remains nearly unaffected; only toward the end, shortly before armature 12 touches internal pole 11, do hydraulic forces build up due to the dynamic pressure. The opening operation is therefore not affected significantly by the dynamic pressure, so that the opening time remains short.

The present invention is not confined to the embodiment shown, and may also be implemented with many other fuel injector designs.

What is claimed is:

1. A fuel injector (1) for fuel injection systems of internal combustion engines, comprising a solenoid (8), an armature (12) acted upon in a closing direction by a restoring spring (10), and a valve needle (3) frictionally engaged with the armature (12) to actuate a valve-closure member (4) which, together with a valve-seat surface (6), forms a sealing seat, at least one first fuel channel (37) through which the fuel flows, being provided in or on the armature (12) wherein the cross-section of the first fuel channel (37) is dependent on the axial position of the armature (12).

2. The fuel injector according to claim 1, wherein the first fuel channel (37) includes at least one axial equalizing channel (31) which is positioned between the armature (12) and a stationary pole (15), and a radial working gap (33) between the armature (12) and an internal pole (11).

3. The fuel injector according to claim 2, wherein situated between the armature (12) and the stationary pole (15) is an armature annulus (32) which is connected to the at least one equalizing channel (31).

4. The fuel injector according to one of claims 1 through 3, wherein a second fuel channel (38) is provided in or on the armature (12) whose cross-section is not dependent on the axial position of the armature (12).

5. The fuel injector according to claim 4, wherein in a closed position of the sealing seat, both the first fuel channel (37) and the second fuel channel (38) are open, and in an open position of the sealing seat, only the second fuel channel (38) is open, but not the first fuel channel (37).

6. The fuel injector according to claim 4 or 5, wherein the second fuel channel (38) is formed by a bore (30) in the armature (12).

7. The fuel injector according to one of claims 4 through 6, wherein in the open state of the fuel injector (1), dynamic pressure builds up at the second fuel channel (38), which accelerates the armature (12) in the closing direction.
